(19) United States
(12) Patent Application Publication
(10) Pub. No.: US 2016/0260275 A1
(43) Pub. Date: Sep. 8, 2016

(54) RAPID CONVEYANCE OF COINS BY ROTATING CONVEYOR BELTS

(71) Applicant: Xerox Corporation, Norwalk, CT (US)

(72) Inventors: Andrew S. Noren, Hertfordshire (GB); Simon J. Gray, Bedfordshire (GB); John K. Mangan, Hertfordshire (GB); Peter D. Fraser, Hertfordshire (GB); David R. Ascroft, Hertfordshire (GB)

(21) Appl. No.: 14/636,246

(22) Filed: Mar. 3, 2015

(51) Int. Cl. G07D 3/06

(52) U.S. Cl. CPC G07D 3/06

(57) ABSTRACT

Systems and methods herein convey a coin that is verified and sorted as to one of a plurality of denominations, by a coin verifier, that sorts the coin to a corresponding one of a plurality of rotating conveyor belts equal in number to the number of denominations. The corresponding one of the plurality of rotating conveyor belts rapidly conveys the sorted coin of one denomination at a constant speed to a drop point disposed above a corresponding one of a plurality of coin storage devices, whereupon the sorted coin of one denomination is dropped into the corresponding one of the plurality of coin storage devices.

### BACKGROUND

Systems and methods herein generally relate to coin payment systems, and more particularly to verification and sorting of coins.

A useful aspect of coin payment systems is the rapidity with which payments of multiple coins of various denominations can be made. A system and method that conveys a coin to a coin storage device can include a coin carriage, which transports the coin from a coin verifier to the coin storage device. Referring to FIG. 1, the coin verifier 102 verifies the denomination of an inserted coin by, for example, any of optical, electromagnetic, and/or mechanical means. Upon completing coin verification, the coin 104 is dropped from the coin verifier 102 into the coin carriage 106, which is disposed at a home position 108 on a single transport track 110. Detection of the dropped coin 104 by the coin carriage 106 begins transport of the coin 104 within the coin carriage 106 along the single transport track 110. Based on the verified coin's denomination, the coin carriage 106, which is driven by a stepper motor, transports the coin 104 from the home position 108 to one of a plurality of destination positions 112 on the single transport track 110. Each one of the destination positions 112 coincides with the position of one of a plurality of coin storage devices 114 that corresponds to one of the plurality of coin denominations. Based on the verified coin's denomination, the coin carriage 106 drops the verified coin 104 at the corresponding destination position into the corresponding coin storage device 114; thus, sorting the coin 104 according to its denomination. The emptied coin carriage 106 then returns to the home position 108 to receive the next coin.

As shown in FIG. 2, a method employed by the above system includes at least the following sequence of processes: coin insertion 202; coin verification 204; coin delivery 206; and carriage return 208. Coin insertion 202 begins with a coin being inserted into a coin inlet and ends with the coin entering the coin verifier 102. The process of coin verification 204 occurs over a period of time, during which the coin verifier 102 cannot accept another coin. After coin verification 204, the coin is dropped into the coin carriage 106, which then begins coin delivery 206 to a destination position 122, based on the coin's denomination and coinciding with the position of one of the coin storage devices 114; thus, sorting the coin by denomination. After coin delivery 206, the emptied coin carriage 106 returns to its home position 108, i.e., carriage return 208. It is only after carriage return 208 that the coin verifier 102 can accept another coin; thus, ensuring that the coin carriage 106 is disposed at the home position 108 to receive another coin 104 from the coin verifier 102.

The sequence of processes above presents several issues for a system that rapidly conveys a coin via a coin carriage to a coin storage device. During rapid transport, the stepper motor driving the coin carriage along the single transport track must attain high torques to both start and stop the coin carriage and to reverse direction of the coin carriage, causing frequent stalls. Furthermore, accurately stopping the coin carriage at the destination positions for each of the plurality of coin storage devices again uses high torques and is subject to error. In addition, the time to both deliver the coin and to return the emptied carriage can preclude rapid throughput for the system.

Thus, a coin payment system that rapidly and reliably conveys a coin that is verified and sorted as to one of a plurality of denominations, to a corresponding one of a plurality coin storage devices, is useful.

### SUMMARY

The following summary is provided to facilitate an understanding of some of the innovative features unique to the disclosed systems and methods and is not intended to be a full description. A full description of the various aspects of the systems and methods disclosed herein can be gained by taking the entire specification, claims, drawings, and abstract as a whole.

The systems herein may include a coin verifier that verifies a number of denominations of coins, e.g., four denominations. The coin verifier may sort each denomination of the number of denominations of coins to a corresponding one of the same number of coin passageways, e.g., four passageways. Each of the number of coin passageways may be disposed above a corresponding one of the same number of rotating conveyor belts, e.g., four rotating conveyor belts, and may drop a single coin denomination to a coin slot of a succession of coin slots disposed on the corresponding one of the rotating conveyor belts. Each of the rotating conveyor belts may have a fixed length to a drop point. The system may also include the same number of coin storage devices, e.g., four coin storage devices. Each of the coin storage devices may be disposed beneath the drop point of each of the corresponding ones of the rotating conveyor belts, and may store a single denomination of coin from each of the corresponding ones of the rotating conveyor belts.

The methods herein may include verifying, by a coin verifier, one of the denominations of coins to provide denomination information for an inserted coin. The method may also include sorting, by the coin verifier, the inserted coin based on the denomination information to a corresponding one of the coin passageways. The method may further include dropping the inserted coin from the corresponding one of the coin passageways to a coin slot of a succession of coin slots disposed on a corresponding one of the rotating conveyor belts, where each of the rotating conveyor belts rotates at a constant linear speed. The method may yet further include transporting the inserted coin in the coin slot to a drop point coinciding with a fixed distance corresponding to a length of one of the rotating conveyer belts. Finally, the method may include dropping the inserted coin from the coin slot to a corresponding one of the coin storage devices.

Other methods herein may include starting a transaction for a coin payment system upon introducing a coin to one of the number of denominations of coins, where the transaction includes denomination information for the coin. The method may also include activating all of the same number of rotating conveyor belts, where one of the conveyor belts subsequently sorts and transports the coin of the one of the coins, based on the denomination information. The method may further include delivering the coin to a drop point coinciding with a fixed distance corresponding to a length of one of the rotating conveyer belts and dropping the coin into a corresponding one of the same number of coin storage devices. The method may yet further include stopping the transaction to provide the denomination information. Finally, the method may include stopping the rotation of all of the rotating conveyor belts.

These and other features are described in or are apparent from, the following detailed description.

### BRIEF DESCRIPTION OF THE DRAWINGS

Various exemplary systems and methods are described in detail below, with reference to the attached drawing figures, in which:

FIG. 1 is a schematic diagram illustrating a coin payment system in the related art;

FIG. 2 is a schematic diagram illustrating a sequence of events for the coin payment system of in FIG. 1 in the related art;

FIG. 3 is a schematic perspective of a coin payment system herein, employing a number of rotating conveyor belts for rapid conveyance of coins;

FIG. 4 is a schematic diagram illustrating a side view of an aligned forward facing coin falling into a coin slot of a coin payment system herein;

FIG. 5 is a schematic diagram illustrating a side view of a misaligned forward facing coin failing to fall into a coin slot of a coin payment system herein;

FIG. 6 is a schematic diagram illustrating a side view of an aligned edgewise coin falling into a coin slot of a coin payment system herein;

FIG. 7 is a schematic diagram illustrating a side view of a misaligned edgewise coin failing to fall into a coin slot of a coin payment system herein;

FIG. 8 is a schematic diagram illustrating a sequence of events for coin payment systems herein;

FIG. 9 is a flowchart illustrating a method of a coin payment system herein; and

FIG. 10 is a flowchart illustrating another method of a coin payment system herein.

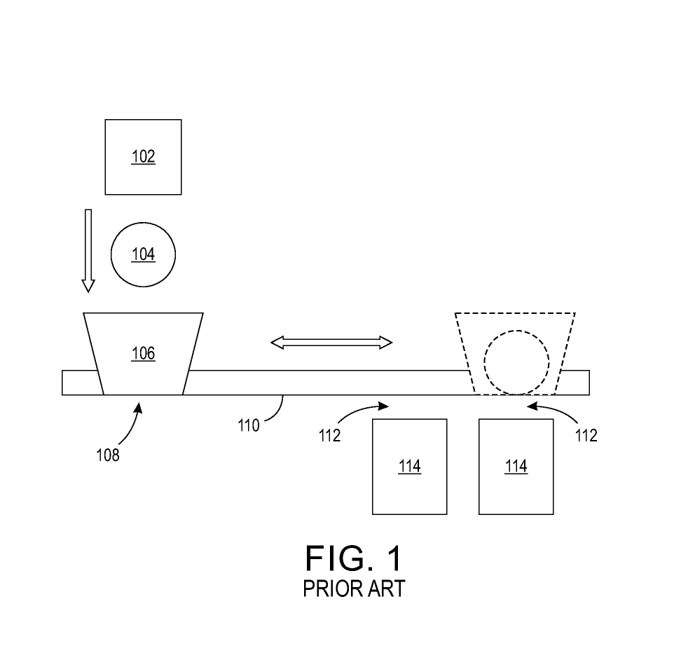

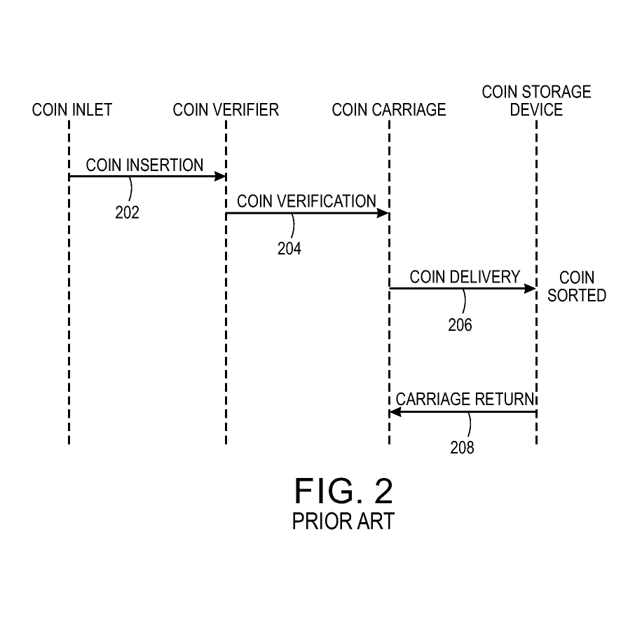

### DETAILED DESCRIPTION

As stated above, a coin payment system that rapidly and reliably conveys a coin that is verified and sorted as to one of a plurality of denominations, to a corresponding one of a plurality coin storage devices is useful. The systems and methods herein may rapidly and reliably convey a coin that is verified and sorted as to one of a plurality of denominations, only to a corresponding one of a plurality of rotating conveyor belts, whereupon the corresponding one of the plurality of rotating conveyor belts rapidly conveys the coin of the one of the plurality of denominations only to a corresponding one of a plurality of coin storage devices. Thus, each denomination of a coin may be conveyed by a corresponding one of a plurality of rotating conveyor belts only to a corresponding one of a plurality of coin storage devices.

In other words, the systems and methods herein only accept a limited number of denominations of coins and reject any coins that do not match the accepted denominations. To verify, sort, convey, and store these coins, these systems and methods provide a dedicated conveyor belt, a dedicated slot, and a dedicated storage container for each different coin denomination. Therefore, these systems and methods only contain the exact number of conveyor belts, slots, and storage devices that match the limited number of denominations of coins that are accepted by the devices described herein. Therefore, if the device accepts four different denominations of coins, the device will only include four conveyor belts, four slots, and four storage devices, one for each denomination.

Further, the term “denomination” herein is intended to refer to a coin having a different currency value that is distinguished from other coins by certain physical characteristics, such a diameter, thickness, pattern, roundness, etc. Therefore, one coin of one denomination will have a different currency value, different diameter, different thickness, different pattern, and/or different roundness.

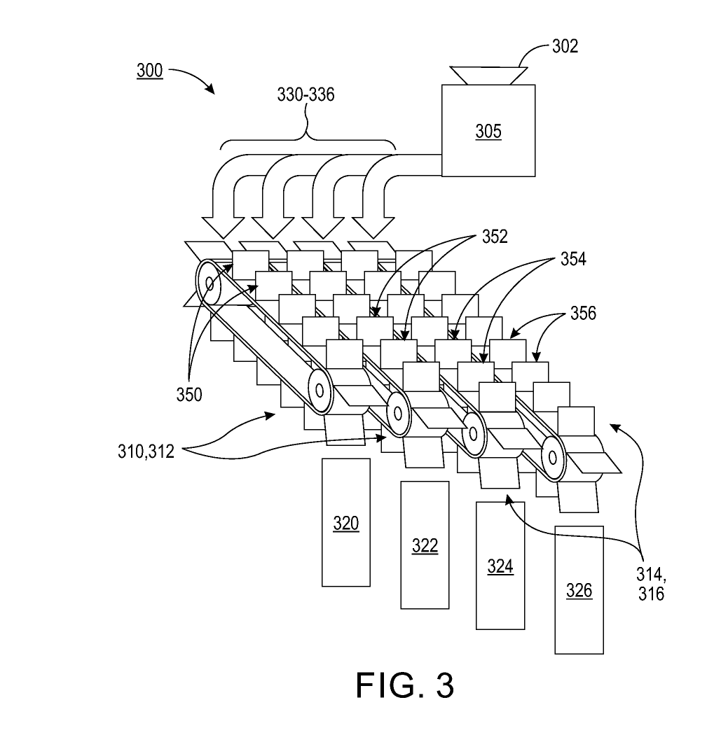

Referring to FIG. 3, a coin payment system 300 may include a coin verifier 305 that only accepts a fixed number, e.g., 4, 5, 6, 7, or 8, of coin denominations; a same number, e.g., 4, 5, 6, 7, or 8, of rotating conveyor belts 310-316, where each one of rotating conveyor belts 310-316 only accepts one of the coin denominations in a succession of coin slots 350-356; and a same number, e.g., 4, 5, 6, 7, or 8, of coin storage devices 320-326, where each one of the coin storage devices 320-326 only accepts a coin of a single denomination from a coin slot 350-356 of one of the rotating conveyor belts 310-316.

The coin verifier 305 may receive any of the coin denominations from a coin inlet 302, where an individual may insert coins. All of the rotating conveyor belts 310-316 may begin rotating at any time between insertion of a coin into the system and entry of the coin into the coin verifier 305. After a period of time to verify the denomination of a coin, the coin verifier 305 may release the coin only to a corresponding one of the coin passageways 330-336, where each of the coin passageways 330-336 is aligned with and feeds the coin slots 350-356 of the corresponding ones of the rotating conveyor belts 310-316.

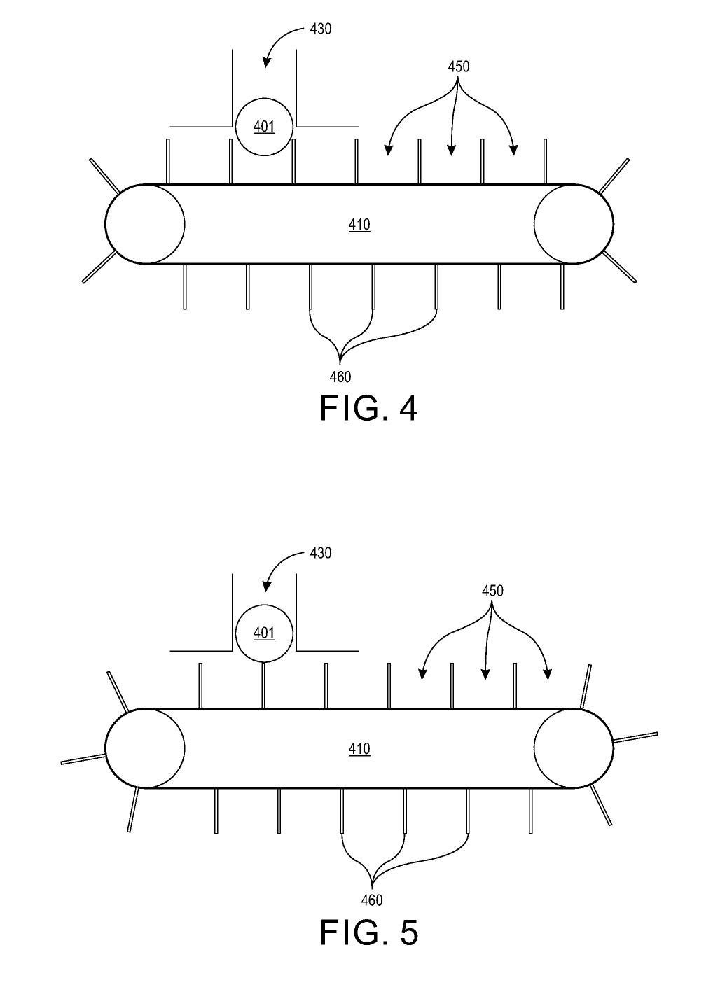

FIG. 4 illustrates the verified coin 401 facing forward in relation to the rotating conveyor belt 410 with its succession of coin slots 450. When released from the coin verifier to the coin passageway 430, the verified coin 401, i.e., a coin of a known denomination, diameter and thickness, may readily drop into a moving coin slot 450 bounded by fins 460 on a rotating conveyor belt 410, if the coin slot 450 and the coin passageway 430 are aligned. In general, the width and depth of the coin passageway 430 are only slightly larger than those of the coin's diameter and thickness, respectively, and are parallel to the width and depth of each coin slot 450. The width and depth of each coin slot 450 on the rotating conveyor belt 410 may be greater than that of the diameter and thickness, respectively, of the verified coin 401, to facilitate dropping the coin 401 into the moving coin slot 450. For example, the width and depth of the coin slot 450 may vary between 1.2 times and 1.8 times the diameter and thickness of the verified coin 401. However, the width and depth of the coin slot 450 may not be equal to or greater than 2.0 times the diameter and/or the thickness of the verified coin 401, because the coin slot 450 may only contain a single coin.

If, however, as shown in FIG. 5, the coin passageway 430 is not aligned with the moving coin slot 450, the coin 401 will not drop into the coin slot 450. In this case, the coin 401 may “roll over” a fin 560 separating two successive moving coin slots 450 on the rotating conveyor belt 410 and drop into the following coin slot 450′ when it is aligned with the coin path 430.

In general, to accommodate the misalignment of the coin passageway 430 with the moving coin slot 450, the linear speed of the rotating conveyor belt 410 may be greater than twice the width of the coin slot 450 divided by the period of time to verify the denomination of the coin. With such a linear speed, even successively fed coins of the same denomination will be separated by at least one coin slot 450 along the rotating conveyor belt 410.

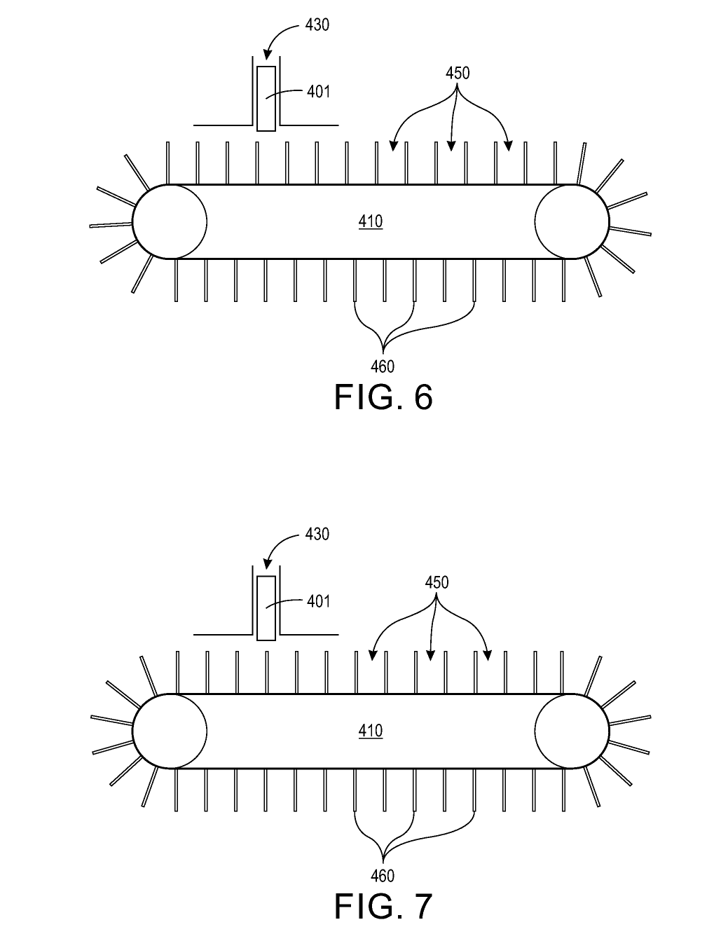

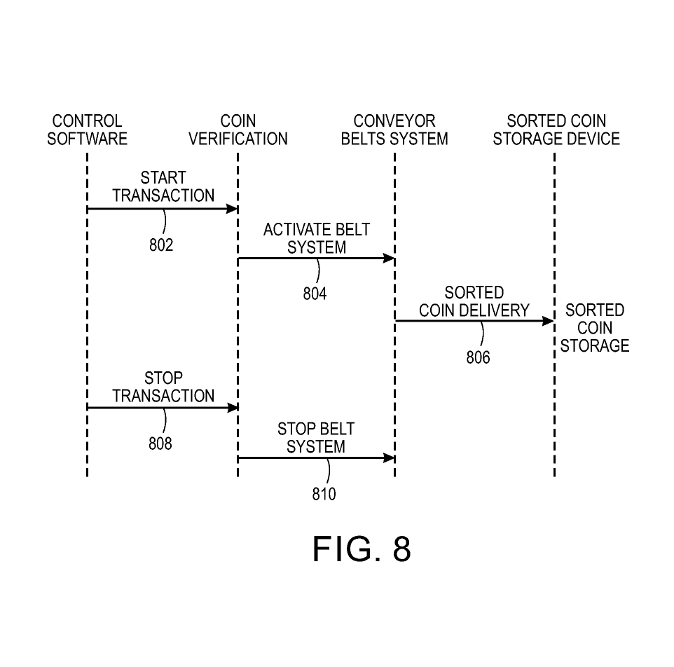

Alternatively, FIG. 6 illustrates the verified coin 601 edgewise in relation to the rotating conveyor belt 610 with its succession of coin slots 650. When released from the coin verifier to the coin passageway 630, the verified coin 601, i.e., a coin of a known denomination, diameter, and thickness, may readily drop into a moving coin slot 650 bounded by fins 660 on a rotating conveyor belt 610, if the coin slot 650 and the coin passageway 630 are aligned. In general, the width and depth of the coin passageway 630 are only slightly larger than those of the coin's thickness and diameter, respectively, and are parallel to the width and depth of each coin slot 450. The width and depth of each coin slot 650 on the rotating conveyor belt 610 may be greater than that of the thickness and diameter, respectively, of the verified coin 601, to facilitate dropping the coin 601 into the moving coin slot 650. For example, the width and depth of the coin slot 650 may vary between 1.2 times and 1.8 times the thickness and the diameter of the verified coin 601. However, the coin slot 650 may not be equal to or greater than 2.0 times the diameter and/or the thickness of the verified coin 601, because the coin slot 650 may only contain a single coin.

If, however, as shown in FIG. 7, the coin passageway 630 is not aligned with the moving coin slot 650, the verified coin 601 will not drop into the coin slot 650. In this case, the verified coin 601 may “slide over” a fin 760 separating two successive moving coin slots 650 and drop into the following coin slot 650′ when it is aligned with the coin passageway 630.

Again, to accommodate the misalignment of the coin passageway 630 with the moving coin slot 650, the linear speed of the rotating conveyor belt may be greater than twice the width of the coin slot 650 divided by the period of time to verify the denomination of a coin. With such a linear speed, even successively fed coins of the same denomination will be separated by at least one coin slot 650 along the rotating conveyor belt.

Referring to FIG. 3, after a coin is dropped from the coin verifier 305 to a moving coin slot 350-356 on a corresponding one of the rotating conveyer belts 310-316, the coin is transported a fixed distance corresponding to a length of one of the rotating conveyer belts 310-316, only to a drop point above a corresponding one of the coin storage devices 320-326, which stores the single corresponding coin denomination. The coin may drop from one of the corresponding the rotating conveyor belts 310-316 to one of a: coin vault, coin bucket, and coin passageway that is interposed between the rotating conveyor belt and the corresponding one of the coin storage devices 320-326. The coin storage devices 320-326 may comprise any of a coin box and a coin drum.

The system may improve reliability by employing a motor (not shown) that provides a constant motor speed to the system of conveyor belts for the coin delivery. The linear speeds of each of the rotating conveyor belts 310-316 may be pre-determined and achieved by the means of one of: gear ratios between the driver gear of a constant motor speed and each of the driven output gears for each of the corresponding the rotating conveyor belts 310-316; and pulley ratios between the driver pulley of a constant motor speed and each of the driven output pulleys for each of the corresponding the rotating conveyor belts 310-316. Employing a constant motor speed may result in fewer, if any stalls, and less jamming than that which occurs in a system employing a coin carriage that reverses direction.

The system 300 may have a high throughput because there is no need to inhibit acceptance of a coin by the coin verifier 305 until a coin carriage returns to its home position. Instead, the coin verifier's throughput is only limited by the time period to verify a coin and is not subject to delay caused by coin delivery or carriage return.

The systems 300 herein may include a coin verifier 305 that verifies the denominations of coins. The coin verifier 305 may sort each denomination of coin only to a corresponding one of the coin passageways 330-336. Each of the coin passageways 330-336 may be disposed above a corresponding one of the rotating conveyor belts 310-316 and may drop a single coin denomination only to a coin slot of a succession of coin slots 350-356 disposed on the corresponding one of the rotating conveyor belts 310-316. Each of the rotating conveyor belts 310-316 may have a fixed length to a drop point. The system 300 may also include the coin storage devices 320-326. Each of the coin storage devices 320-326 may be disposed beneath the drop point of each of the corresponding ones of the rotating conveyor belts 310-316, and may store the coin of the single denomination from each of the corresponding ones of the rotating conveyor belts 310-316.

In the system 300, each of the coin passageways 330-336 may have a width and a depth slightly larger than a diameter and a thickness, respectively, of a coin of one of the coin denominations. Each of the coin passageways 330-336 may also have a width and a depth that are parallel to a width and depth of each coin slot 350-356 on each corresponding one of the rotating conveyor belts 310-316. Each coin slot 350-356 on each corresponding one of the rotating conveyor belts 310-316 may have a width and a depth varying between 1.2 times and 1.8 times the diameter and the thickness, respectively, of the coin.

Alternatively, in system 300, each of the coin passageways 330-336 may have a width and a depth slightly larger than a thickness and a diameter, respectively, of a coin of one of the coin denominations. Each of the coin passageways 330-336 may have a width and a depth that are parallel to a width and depth of each coin slot on each corresponding one of rotating conveyor belts 310-316. Each coin slot on each corresponding one of the rotating conveyor belts 310-316 may have a width and a depth varying between 1.2 times and 1.8 times the thickness and the diameter, respectively, of the coin.

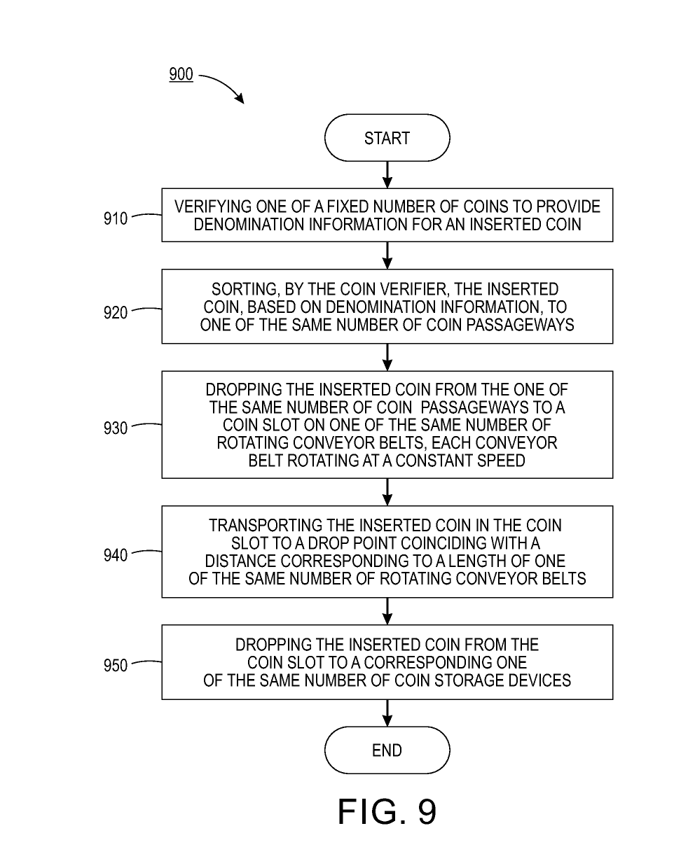

FIG. 9 is a flowchart illustrating an exemplary method of coin payment 900 that may include verifying, by a coin verifier, one of the denominations of coins to provide denomination information for an inserted coin 910. The method may also include sorting, by the coin verifier, the inserted coin based on the denomination information only to a corresponding one of the coin passageways 920. The method may further include dropping the inserted coin from the corresponding one of the coin passageways only to a coin slot of a succession of coin slots disposed on a corresponding one of the rotating conveyor belts, where each of the rotating conveyor belts rotates at a constant linear speed 930. The method may yet further include transporting the inserted coin in the coin slot to a drop point coinciding with a fixed distance corresponding to a length of one of the rotating conveyer belts 940. Finally, the method may include dropping the inserted coin from the coin slot only to a corresponding one of the coin storage devices 950.

The above method may further include initially introducing the inserted coin into a coin inlet for a coin payment system. The method may also include, before dropping the inserted coin to the coin slot, activating all of the rotating conveyor belts to a constant speed. The constant speed for each of the rotating conveyor belts may be greater than twice a width of the coin slot divided by a period of time to verify the denomination information. The method may further include, after dropping of the inserted coin to the corresponding one of the coin storage devices, stopping the verifying to provide denomination information. The method may yet further include, after the stopping of the verifying process to provide denomination information, stopping rotation of all of the rotating conveyor belts.

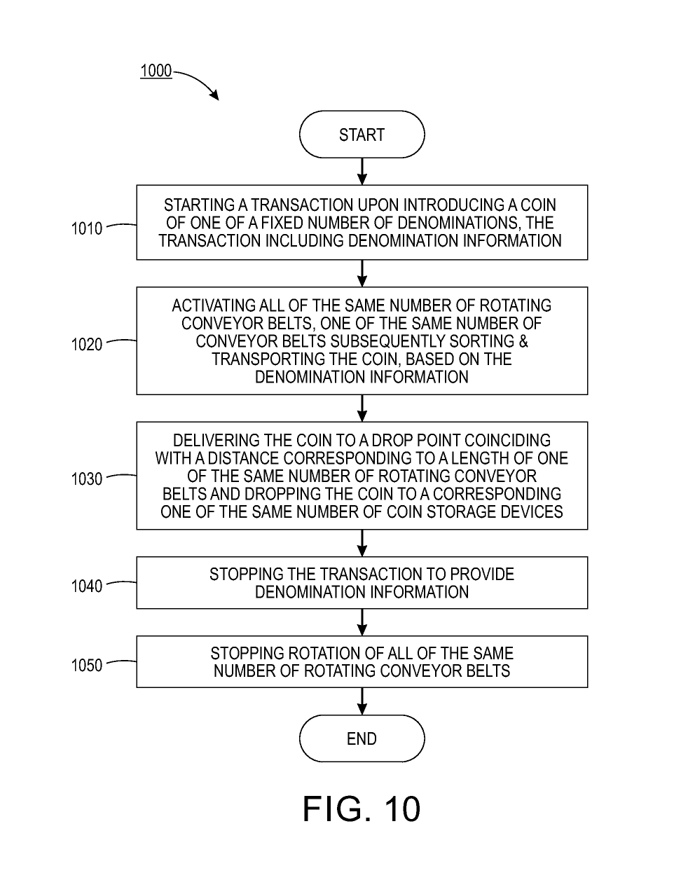

FIG. 10 is a flowchart illustrating an exemplary method of coin payment 1000 that may include starting a transaction for a coin payment system upon introducing a coin of one of the fixed number of denominations of coins, where the transaction includes denomination information for the coin 1010. The method may also include activating all of the rotating conveyor belts, where one of the conveyor belts subsequently sorts and transports the coin, based on the denomination information 1020. The method may further include delivering the coin only to a drop point coinciding with a fixed distance corresponding to a length of one of the rotating conveyer belts and dropping the coin into a corresponding one of the coin storage devices 1030. The method may yet further include stopping the transaction to provide the denomination information 1040. Finally, the method may include stopping the rotation of all of the rotating conveyor belts 1050.

The above method may further include providing the denomination information by a coin verifier after introducing the coin. The method may also include sorting of the coin to the one of the conveyor belts by the coin verifier, being based on the denomination information. Each of the conveyor belts may comprise a succession of coin slots, whereby the coin is received by a single coin slot of the succession of coin slots. The method may yet further include delivering of the coin only to a drop point, coinciding with a fixed distance corresponding to a length of one of the rotating conveyer belts, at a constant speed. The constant speed for each of the rotating conveyor belts may be greater than twice a width of the coin slot divided by a period of time to verify the denomination information. Each of the coin storage devices may store only one of the fixed number of denominations of coins.

While some exemplary structures are illustrated in the attached drawings, those ordinarily skilled in the art would understand that the drawings are simplified schematic illustrations and that the claims presented below encompass many more features that are not illustrated (or potentially many less) but that are commonly utilized with such devices and systems. Therefore, Applicants do not intend for the claims presented below to be limited by the attached drawings, but instead the attached drawings are merely provided to illustrate a few ways in which the claimed features can be implemented.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements). Further, the terms automated or automatically mean that once a process is started (by a machine or a user), one or more machines perform the process without further input from any user.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

1. A system, comprising:
a coin verifier that verifies a fixed number of denominations of coins, said coin verifier sorting each denomination of said fixed number of denominations of coins to a corresponding one of said fixed number of coin passageways;
each of said fixed number of coin passageways being disposed above a corresponding one of said fixed number of rotating conveyor belts and dropping a single coin denomination to a coin slot of a succession of coin slots disposed on said corresponding one of said fixed number of rotating conveyor belts, each of said fixed number of rotating conveyor belts having a fixed length to a drop point; and
said fixed number of coin storage devices, each of said fixed number of coin storage devices being disposed beneath said drop point of each of said corresponding ones of said fixed number of rotating conveyor belts and storing said coin of said single denomination from each of said corresponding ones of said fixed number of rotating conveyor belts in a coin payment system.

2. The system of claim 1, each of said fixed number of coin passageways having a width and a depth slightly larger than a diameter and a thickness, respectively, of a coin of one of said fixed number of coin denominations.

3. The system of claim 2, each of said fixed number of coin passageways having a width and a depth that are parallel to a width and depth of each coin slot on each corresponding one of said fixed number of rotating conveyor belts.

4. The system of claim 3, each coin slot on each corresponding one of said fixed number of rotating conveyor belts having a width and a depth varying between 1.2 times and 1.8 times said diameter and said thickness, respectively, of said coin.

5. The system of claim 1, each of said fixed number of coin passageways having a width and a depth slightly larger than a thickness and a diameter, respectively, of a coin of one of said fixed number of coin denominations.

6. The system of claim 5, each of said fixed number of coin passageways having a width and a depth that are parallel to a width and depth of each coin slot on each corresponding one of said fixed number of rotating conveyor belts.

7. The system of claim 6, each coin slot on each corresponding one of said fixed number of rotating conveyor belts having a width and a depth varying between 1.2 times and 1.8 times said thickness and said diameter, respectively, of said coin.

8. A method, comprising:
verifying, by a coin verifier, one of a fixed number of denominations of coins to provide denomination information for an inserted coin;
sorting, by said coin verifier, said inserted coin based on said denomination information to a corresponding one of said fixed number of coin passageways;
dropping said inserted coin from said corresponding one of said fixed number of coin passageways to a coin slot of a succession of coin slots disposed on a corresponding one of said fixed number of rotating conveyor belts, each of said fixed number of rotating conveyor belts rotating at a constant linear speed;
transporting said inserted coin in said coin slot to a drop point coinciding with a fixed distance corresponding to a length of one of said fixed number of the rotating conveyer belts; and
dropping said inserted coin from said coin slot to a corresponding one of said fixed number of coin storage devices.

9. The method of claim 8 further comprising, initially introducing said inserted coin into a coin inlet for a coin payment system.

10. The method of claim 8 further comprising, before dropping said inserted coin to said coin slot, activating all of said fixed number of rotating conveyor belts to a constant speed.

11. The method of claim 10, said constant speed for each of said fixed number of rotating conveyor belts being greater than twice a width of said coin slot divided by a period of time to verify said denomination information.

12. The method of claim 8 further comprising, after said dropping said inserted coin to said corresponding one of said fixed number of coin storage devices, stopping said verifying to provide denomination information.

13. The method of claim 8 further comprising, after said stopping of said verifying to provide denomination information, stopping rotation of all of said fixed number of rotating conveyor belts.

14. A method, comprising:
starting a transaction for a coin payment system upon introducing a coin of one of a fixed number of denominations of coins to a coin verifier that sorts said coin to a corresponding one of the fixed number of coin passageways, which in turn drops the coin to a corresponding one of the fixed number of conveyor belts, said transaction including denomination information for said coin;
activating all of said fixed number of rotating conveyor belts, one of said fixed number of conveyor belts subsequently sorting and transporting said coin of said one of said fixed number of denominations of coins, based on said denomination information;
delivering said coin to a drop point coinciding with a fixed distance corresponding to a length of one of said fixed number of the rotating conveyer belts and dropping said coin to a corresponding one of said fixed number of coin storage devices;
stopping said transaction to provide denomination information; and
stopping rotation of all of said fixed number of rotating conveyor belts.

15. The method of claim 14, said denomination information being provided by a coin verifier after introducing said coin.

16. The method of claim 15, said sorting of said coin to said one of said fixed number of conveyor belts by said coin verifier, being based on said denomination information.

17. The method of claim 16, each of said fixed number of conveyor belts comprising a succession of coin slots, whereby said coin is received by a single coin slot of said succession of coin slots.

18. The method of claim 17, said delivering of said coin to a drop point, coinciding with a fixed distance corresponding to a length of one of said fixed number of the rotating conveyer belts, at a constant speed.

19. The method of claim 18, said constant speed for each of said fixed number of rotating conveyor belts being greater than twice a width of said coin slot divided by a period of time to verify said denomination information.

20. The method of claim 14, each of said fixed number of coin storage devices storing one of said fixed number of denominations of coins.
